(19) United States
(12) Patent Application Publication
(10) Pub. No.: US 2015/0178466 A1
(43) Pub. Date: Jun. 25, 2015

(54) METHODS FOR AGGREGATE REPORTING OF HEALTH DATA AND DEVICES THEREOF

(71) Applicant: HEALTH DIAGNOSTIC LABORATORY, INC., Richmond, VA (US)

(72) Inventors: J. Andrew RICHARDSON, Highland Springs, VA (US); Anna MCKEAN, Glen Allen, VA (US); Shahrzad GRAMI, Richmond, VA (US)

(21) Appl. No.: 14/579,639

(22) Filed: Dec. 22, 2014

Related U.S. Application Data
(60) Provisional application No. 61/920,306, filed on Dec. 23, 2013.

(51) Int. Cl. G06F 19/00

(52) U.S. Cl. CPC G06F 19/3431; G06F 19/3443; G06F 19/322

(57) ABSTRACT

A method for aggregate reporting of health data includes obtaining health data for a plurality of subjects in a population associated with an entity, the health data comprising diagnostic laboratory testing results, biometric information, or demographic information. Each of the subjects is allocated to one or more dimensions based on the obtained health data and one or more boundary conditions of each of the dimensions, the dimensions corresponding to biometric or demographic information of a specified type. Whether a number of subjects allocated to one of the dimensions is below a threshold is determined. One or more of the boundary conditions for one or more of the dimensions is adjusted when the number of subjects allocated to the one dimension is determined to be below the threshold. The determining and the adjusting are repeated until a number of subjects allocated to the dimensions is not below the threshold.

### CROSS-REFERENCE TO RELATED APPLICATIONS

This application claims the benefit of U.S. Provisional Patent Application Ser. No. 61/920,306, filed Dec. 23, 2013, which is hereby incorporated by reference in its entirety.

### FIELD

This technology generally relates to reporting of diagnostic laboratory testing results and other health data and, more particularly, to methods and devices for generating and providing aggregate health reports for a plurality of subjects associated with an entity.

### BACKGROUND

Diagnostic laboratory testing results can be used to analyze disease states and risk of developing diseases for tested subjects. Individuals can be tested as recommended by a health care provider or as part of a corporate wellness program aimed to improve disease risk of employees, for example. However, there is no way for individuals to compare diagnostic test results to similarly situated individuals sharing demographic and/or biometric characteristic(s) within the diagnostic laboratory information-handling framework. Accordingly, individuals are generally unaware of corresponding results for other individuals, which could otherwise be used to inform and motivate at-risk individuals.

Similarly, entities for which an associated population is tested currently do not have the ability to track or otherwise effectively analyze diagnostic testing results for the population. For example, individual diagnostic testing results for a plurality of patients may be obtained by a health care provider. However, there is currently no way for the health care provider to efficiently analyze the results so as to identify patients for which a treatment has been relatively less effective and for which specific therapeutic intervention may be required.

Additionally, for entities and individuals other than health care providers there is currently no way to organize diagnostic testing results for a population based on demographic attributes so as to ensure anonymity, particularly in small populations of tested subjects. Reporting of diagnostic testing results to an entity prohibited from receiving such confidential information can lead to discrimination based on health status.

Determining effective treatment protocols and identifying relevant health measures via diagnostic laboratory testing involves the testing of individual patients. However extrapolation of measurements and results to a generalized population for determining the effectiveness of the health and testing program and performing research on individual measurements and outcomes relies heavily on collective analysis of the patient data. This may include a wide variety of information: health markers such as the specific levels of analytes in the blood and genetic variations and physically observable health markers such as height, weight, age, and race, lifestyle factors including smoking status, levels of physical activity and diet, biographic information such as participation in government support programs, mental health information and more. Such information is inherently private and legally protected in the United States under the Health Information Portability and Accountability act of 1996 (HIPAA), for example. Therefore a conflict exists between the desire to measure details on a patient population and the privacy requirements surrounding necessary data.

Using the HIPAA standard as an example, the department of Health and Human Services broadly defines protected health information (PHI) as follows: the individual's past, present, or future physical or mental health or condition; the provision of health care to the individual; or the past, present, or future payment for the provision of health care to the individual, and that identifies the individual or for which there is a reasonable basis to believe can be used to identify the individual. Protected health information includes many common identifiers (e.g., name, address, birth date, Social Security Number) when they can be associated with the health information listed above.

Performing any reporting to a non-privileged third-party for PHI aggregating purposes requires the de-identification of individually identifiable health information according to multiple standards. The goal is to be sure health information is not individually identifiable if it does not identify an individual and if the covered entity has no reasonable basis to believe it can be used to identify an individual. To achieve this, there are multiple standards including the Expert Determination method, which incorporates the following standard according to Section 164.514(a) of the HIPAA Privacy Rule:

A covered entity may determine that health information is not individually identifiable health information only if:

A person with appropriate knowledge of and experience with generally accepted statistical and scientific principles and methods for rendering information not individually identifiable: (i) Applying such principles and methods, determines that the risk is very small that the information could be used, alone or in combination with other reasonably available information, by an anticipated recipient to identify an individual who is a subject of the information; and (ii) Documents the methods and results of the analysis that justify such determination

Other jurisdictions, organizations, governing bodies and general ethical standards may have different, but very similar guidelines for the protection of personal health information. In every case, the problem of isolating some information while generating useful and/or statistically-relevant results is a major technical problem to be overcome.

In the course of making a determination for compliance with the HIPAA Privacy Rule or alternative standard, an expert is required to generate, review, recalculate, and iteratively review any set of data. However, as the number of identifiable measurements and patient population grows for an aggregation study, the computational complexity grows exponentially: far beyond the capability of an expert to characterize the effective and appropriate categorization of data. It is simply not possible for a human actor to sort through all the possible permutations of variables and outcomes to generate all meaningful results in a study, as such analysis can only be performed iteratively encompassing all variables with incremental modifications to variable categorizations in each iteration. Furthermore, there is no system capable of collecting and associating patient biometric data and laboratory results and generating population analyses without compromising PHI.

There is a significant need for an efficient mode of testing, analysis, and reporting to address the problem of health research involving PHI.

### SUMMARY

In an aspect, methods for aggregate reporting of health data are disclosed. One exemplary method includes obtaining with an aggregate reporting computing device health data for a plurality of subjects in a population associated with an entity, the health data comprising diagnostic laboratory testing results, biometric information, or demographic information. Each of the subjects is allocated with the aggregate reporting computing device to one or more dimensions based on the obtained health data and one or more boundary conditions of each of the dimensions, the dimensions corresponding to biometric or demographic information of a specified type. Whether a number of subjects allocated to one of the dimensions is below a threshold is determined with the aggregate reporting computing device. One or more of the boundary conditions for one or more of the dimensions is adjusted with the aggregate reporting computing device when the number of subjects allocated to the one dimension is determined to be below the threshold. The determining and the adjusting are repeated with the aggregate reporting computing device until a number of subjects allocated to the dimensions is not below the threshold.

Another exemplary method includes obtaining, with an aggregate reporting computing device, health data for each of a plurality of subjects in a population associated with an entity, the health data comprising one or more of diagnostic laboratory testing results, biometric information, or demographic information. Condition values for one or more conditions for each subject are determined with the aggregate reporting computing device based on the health data. Aggregate health data and aggregate condition values are calculated with the aggregate reporting computing device for at least a subset of the population based on the health data and the condition values, respectively. At least one of the aggregate health data or aggregate condition values associated with the at least a subset of the population is provided with the aggregate reporting computing device to the entity.

This technology provides a number of advantages including methods, non-transitory computer readable media, and devices that generate a health report that aggregates health data including diagnostic laboratory testing results for a plurality of subjects associated with an entity. The information included in the aggregate health report can be accessed by entities such as corporations or health care providers, for example. In other examples, the information is used by subjects to compare individual results to aggregate results as a motivational tool. Additionally, this technology can prevent disambiguation of the identity of subjects, depending on the recipient of the aggregate health report, to thereby maintain anonymity and satisfy the privacy provisions of the Health Insurance Portability and Accountability Act (HIPAA), for example. This technology provides for efficient aggregation of health data from a number of sources, which improves the functioning of the computing device.

### BRIEF DESCRIPTION OF THE DRAWINGS

FIG. 1 is a block diagram of a network environment which incorporates an exemplary aggregate reporting computing device for facilitating aggregate reporting of health data;

FIG. 2 is a flowchart of an exemplary method for aggregate reporting of health data that maintains anonymity of the tested subjects;

FIG. 3 is a screen shot of aggregate biometric information health data of an exemplary aggregate health report;

FIG. 4 is a screen shot of aggregate condition values of an exemplary aggregate health report; and

FIG. 5 is a flowchart of an exemplary method for comparing health data for a subject to aggregate health data for an associated population.

### DETAILED DESCRIPTION

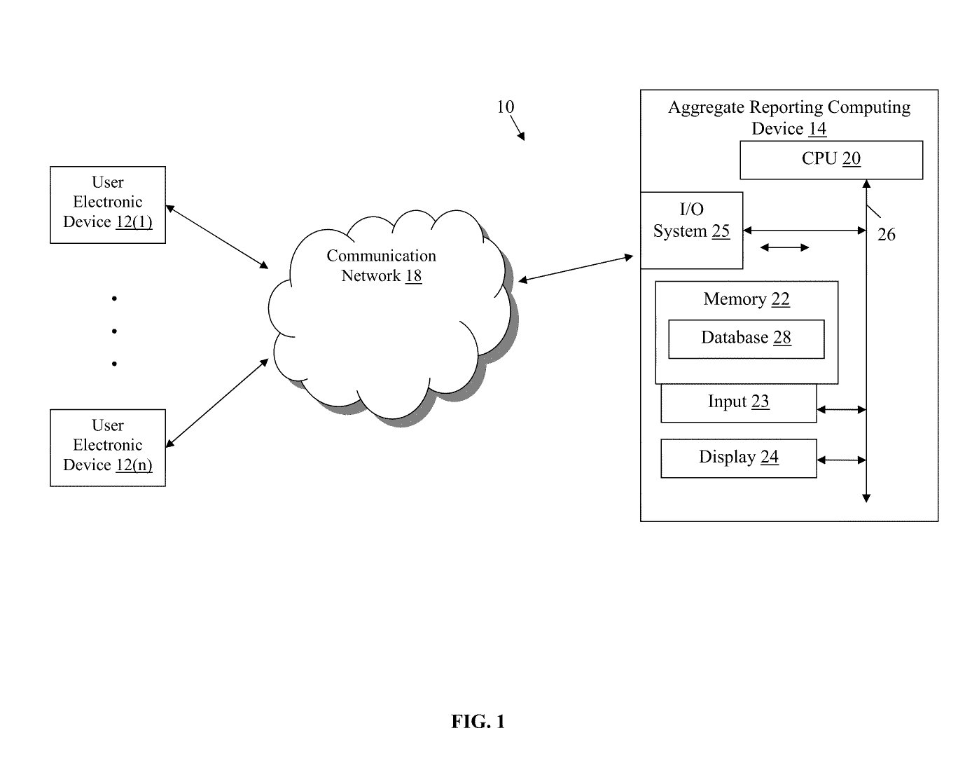

An exemplary network environment 10 with an exemplary aggregate reporting computing device 14 for generating and providing aggregate health reports for a plurality of subjects associated with an entity is illustrated in FIG. 1. The exemplary network environment 10 includes user electronic devices 12(1)-12(n) and the exemplary aggregate reporting computing device 14 which are coupled together by the communication network 18. The exemplary environment 10 can include other numbers and types of systems, devices, components, elements, and/or communication networks in a variety of other topologies and deployments. While not shown, the exemplary environment 10 may include additional components, such as routers, switches and other devices, which are well known to those of ordinary skill in the art and thus will not be described here. This technology provides a number of advantages including methods and devices that facilitate aggregate reporting of health data for a population, such as diagnostic laboratory testing results, while maintaining anonymity of tested subjects.

The aggregate reporting computing device 14 interacts with the user electronic devices 12(1)-12(n) through the communication network 18, although the aggregate reporting computing device can interact with the user electronic devices 12(1)-12(n) using other methods or techniques. The communication network 18 may include local area networks (LAN), wide area network (WAN), 3G technologies, GPRS or EDGE technologies, although the communication network 18 can include other types and numbers of networks and other network topologies.

The aggregate reporting computing device 14 within exemplary network environment 10 is illustrated and described with the examples herein, although the aggregate reporting computing device 14 may perform other types and number of functions in other types of network environments. The aggregate reporting computing device 14 includes at least one processor (CPU) 20, a memory 22, input device 23, display device 24, and an input/output (I/O) system 25, all of which are coupled together by a bus 26 or other link, although aggregate reporting computing device 14 may comprise other types and numbers of elements in other configurations. The processor 20 in the aggregate reporting computing device 14 executes a program of stored instructions for one or more aspects of the present technology as described and illustrated by way of the examples herein, although other types and numbers of processing devices and configurable hardware logic could be used and the processor 20 could execute other numbers and types of programmed instructions.

The memory 22 in the aggregate reporting computing device 14 stores these programmed instructions for one or more aspects of the technology as described and illustrated herein. However, some or all of the programmed instructions could be stored and/or executed elsewhere such as at one or more of the user electronic devices 12(1)-12(n), for example. The memory 22 of the aggregate reporting computing device 14 can store one or more databases 28 for storing content, such as diagnostic laboratory testing results, for example, as described and illustrated in detail below. Optionally, the memory 22 can further store a web application or web service accessible by users of the user electronic devices 12(1)-12(n), to facilitate communication of the plurality of web pages and/or the content stored by the database 28 to the user electronic devices 12(1)-12(n).

A variety of different types of memory storage devices, such as a random access memory (RAM) and/or read only memory (ROM) in the aggregate reporting computing device 14 or a floppy disk, hard disk, CD ROM, DVD ROM, or other medium which is read from and written to by a magnetic, optical, or other reading and writing system that is coupled to the processor 20 in the aggregate reporting computing device 14, can be used for the memory 22. The memory 22 can also include a non-transitory computer readable medium having instructions stored thereon for one or more aspects of the present technology as described and illustrated by way of the examples herein, which when executed by the processor 20, cause the processor 20 to carry out the steps necessary to implement the methods of the examples, as described and illustrated herein.

Input device 23 enables a user, such as an administrator, to interact with the aggregate reporting computing device 14, such as to input and/or view data and/or to configure, program and/or operate it by way of example only. By way of example only, input device 23 may include one or more of a touch screen, keyboard and/or a computer mouse.

The display device 24 enables a user, such as an administrator, to interact with the aggregate reporting computing device 14, such as to view and/or input information and/or to configure, program and/or operate it by way of example only. By way of example only, the display device 23 may include one or more of a CRT, LED monitor, LCD monitor, or touch screen display technology although other types and numbers of display devices could be used.

In one example, the I/O system 25 of the aggregate reporting computing device 14 operatively couples and facilitates communication between the aggregate reporting computing device 14 and the user electronic devices 12(1)-12(n) via the communications network 18, although other types and numbers of communication networks or systems with other types and numbers of connections and configurations can be used. By way of example only, the communications network 18 could use TCP/IP over Ethernet and industry-standard protocols, although other types and numbers of communication networks having their own communication protocols can also be used.

The user electronic devices 12(1)-12(n) can include a central processing unit (CPU) or processor, a memory, a network interface, and an input and/or display device interface, which are coupled together by a bus or other link, although other numbers and types of devices could be used. The user electronic devices 12(1)-12(n) may run interface applications that provide an interface to content, web applications, and/or web services hosted by the aggregate reporting computing device 14 via the communication network 18. The user electronic devices 12(1)-12(n) can include a mobile phone, smart phone, laptop, desktop, tablet, notebook, netbook, personal digital assistant or any other electronic or computing device configured to communicate over the communication network 18.

Although examples of the aggregate reporting computing device 14 are described herein, it is to be understood that the devices and systems of the examples described herein are for exemplary purposes, as many variations of the specific hardware and software used to implement the examples are possible, as will be appreciated by those skilled in the relevant art(s). In addition, two or more computing systems or devices can be substituted for any one of the systems in any embodiment of the examples.

Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those of ordinary skill in the art.

The examples may also be embodied as a non-transitory computer readable medium having instructions stored thereon for one or more aspects of the present technology as described and illustrated by way of the examples herein, as described herein, which when executed by a processor, cause the processor to carry out the steps necessary to implement the methods of the examples, as described and illustrated herein.

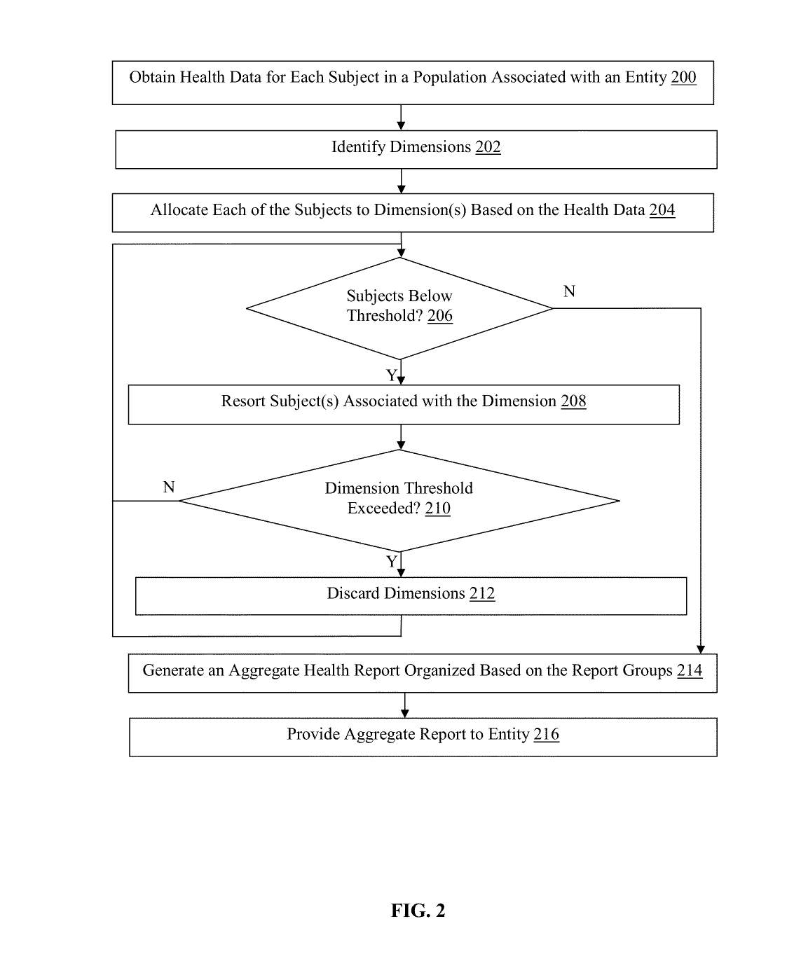

An exemplary method for aggregate reporting of health data will now be described with reference to FIGS. 1-5. Referring more specifically to FIG. 2, an exemplary method for aggregate reporting of health data that maintains anonymity of the tested subjects is illustrated. In this example, in step 200, the aggregate reporting computing device 14 obtains health data for each subject in a population associated with an entity. In some examples, the entity is a health care provider and the subjects are patients of the health care provider. In other examples, the entity is a corporation and the subjects are employees of the corporation. Accordingly, the health data can be obtained by a health care provider interested in analyzing a patient population or as part of a corporate wellness program, for example. In other examples, the entity can be any other type of organization or collection of individuals.

The obtained health data includes at least diagnostic laboratory testing results for the subjects, for instance test results measured from biological samples obtained from the subject. Optionally, the health data further includes biometric information and/or demographic information associated with the subjects. The diagnostic laboratory test results can include measurements of known biomarkers, including biomarkers associated with Apo B, LDL-P, sdLDL, Apo A-I, HDL2, Lp(a) mass, Lp(a) cholesterol, myeloperoxidase, hs-CRP, fibrinogen, galectin-3, NT-proBNP, thromboxane, insulin, C-peptide, free fatty acid, glucose, 25-hydoxy-vitamin D, uric acid, TSH, homocysteine, vitamin B12, total cholesterol, LDL-C direct, HDL-C, triglycerides, and/or non-HDL-C, for example. Results of other diagnostic laboratory tests and/or test panels that include these and/or other biomarkers can also be obtained by the aggregate reporting computing device 14 in step 200. Optionally, the diagnostic laboratory testing results are obtained for each of the subjects from a laboratory that performs the tests and includes at least an identifier of the entity with which each of the subjects is associated.

Diagnostic laboratory testing results are obtained first by collecting a sample from a patient and for the purposes of a collective assessment, from a population of patients. The samples may be blood, serum, plasma, synovial fluid, sputum, saliva, urine, tissue, or similar. The samples may be drawn at a location convenient for the patient such as a remote clinical facility or the patient may visit the laboratory itself for a sample. The sample may be processed then shipped to the laboratory, wherein the sample is labeled with an identification means that will be associated with other biometric and biographical details. The samples are processed and separated into divisions at the laboratory facility for measurement of multiple analytes or genetic tests. The samples or sample divisions are then loaded into instruments that measure the individual biomarkers. These instruments are linked to a laboratory information system, which collects biomarker measurement data and an ID associating said data with a patient at a central processing unit.

In this example, the obtained biometric information includes physical activity, blood pressure, body composition, waist circumference, diet, nicotine use, and/or alcohol use, although other biometric information can also be obtained. Additionally, in this example, the demographic information includes gender, age, body mass index (BMI), weight, height, ethnicity, geographic location, type of employment, historical health events, insurance status, Medicaid usage, work engagements or requirements, and/or family history, although other demographic information can also be obtained. The biometric and/or demographic information can be obtained from processes and sources in parallel with the diagnostic laboratory testing results or separately through a web-based portal provided by the aggregate reporting computing device 14 to users of the user electronic devices 12(1)-12(n), for example.

In particular, biometric information may be collected for the purposes of health screening of a grouping of patients from the patients themselves, via manually-completed forms, through a web-based portal, or communicated to a representative for the entity or diagnostic laboratory verbally. This information is combined with the diagnostic testing results in a central processing unit distinct from the operation of the diagnostic laboratory instrumentation.

The web-based portal can include web page(s) stored in the memory 22 of the aggregate reporting computing device 14 and including form(s) for obtaining the biometric and/or demographic information from the subjects. In examples in which the biometric and/or demographic information is obtained through a web-based portal, the aggregate reporting computing device 14 can match the biometric and/or demographic information with corresponding laboratory test results obtained from the laboratory based on a unique identifier for each of the subjects provided by the subjects or the laboratory or assigned by the aggregate reporting computing device 14, for example.

In step 202, the aggregate reporting computing device 14 identifies dimensions that may be used to generate report groups to be included in a health report, as described and illustrated in more detail later. In this example, the dimensions are a subset of parameters corresponding to a type of biometric or demographic information used to organize the report groups. The corresponding type of biometric or demographic information is information identifiable through casual observation of, or acquaintance with, a subject or review of an employee human resources record for a subject, for example. Additionally, dimensions include divisions of dimensions defined based on boundary conditions. For example, age can be a dimension and age less than 25 can be a dimension.

In step 204, the aggregate reporting computing device 14 allocates each of the subjects to one or more dimensions. In one example, the parameters, dimensions, and/or boundary conditions for the report groups can be provided to the aggregate reporting computing device 14 by a representative of an entity using one of the user electronic devices 12(1)-12(n). In another example, the parameters, dimensions, and/or boundary conditions are default values provided by an administrator of the aggregate reporting computing device 14 and stored in the memory 22.

In step 206, the aggregate reporting computing device 14 determines whether a number of subjects allocated to one of the dimensions is below a threshold. In one example, the aggregate reporting computing device 14 analyzes the dimensions identified in step 202 using vector analysis. Accordingly, subjects can be organized based on dimension into vectors and a count of a number of subjects corresponding to each of the vectors can be determined. Additionally, identified dimensions can be examined in collective groups to prevent groups of dimensions from being used to disambiguate one another. Next, the aggregate reporting computing device 14 generates a matrix of dimensions and subjects for each dimension which is used to determine whether a threshold number of subjects has been exceeded for any of the dimensions.

In one example, a threshold of two subjects may be set so that any dimension must have at least two subjects so as to not single out any one subject. In other cases, a larger threshold may be chosen. Alternatively, the threshold may be set as a ratio of the total number of subjects, or a ratio of a subset of subjects. For example, no less that 1/100th of the subjects may be identified as part of a dimension, or no less than 1/10th of the subjects associated with a particular dimension, such as age for example, may be represented in another dimension. If the aggregate reporting computing device 14 determines in step 206 that the number of subjects allocated to one or more of the dimensions is below the threshold, then the “Yes” branch is taken to step 208.

In step 208, the aggregate reporting computing device 14 resorts subject(s) of one or more of the dimensions to avoid the particular division of the dimension that resulted in the dimension having a number of subjects below the threshold. The one or more dimensions may be resorted by the minimum amount required to avoid subject populations in any dimension falling below the threshold, but to maintain meaningful dimension separations. Resorting may include adding, removing and combining, or changing boundary conditions of the one or more dimensions, although other methods of resorting can also be used.

In one example, if only one subject is associated with an age less than 25 dimension, then the aggregate reporting computing device 14 may increase the boundary condition so that the dimension includes subjects having an age less than 30 resulting in more subjects associated with the dimension. Alternatively, the aggregate reporting computing device 14 may combine dimensions of age less than 25 and age greater than 25 into an age dimension in order to increase the number of subjects above the threshold.

In step 210, the aggregate reporting computing device 14 determines whether resorting resulted in a number of dimensions associated with a same biometric or demographic category falling below a threshold. If the aggregate reporting computing device 14 determines that the number of dimensions associated with a same biometric or demographic category fell below a threshold, then the “Yes” branch is taken to step 212.

In step 212, the aggregate reporting computing device 14 discards the dimensions associated with a same biometric or demographic category. For example, if BMI measurements are compared across age groups, the minimum number of age groups may be set at three, each of which is a dimension and has an associated boundary condition. If fewer than three age groups can be separated out according to BMI without maintaining subject populations above the threshold for each dimension, then the BMI analysis may be discarded altogether.

Following step 212, or if the aggregate reporting computing device 14 determines that the number of dimensions associated with the same biometric or demographic category does not exceeds a threshold in step 210, the method proceeds back to step 206 and the aggregate reporting computing device 14 again determines whether a number of subjects associated with another one of the dimensions exceeds a threshold. Optionally, steps 204-212 can be repeated for all N dimensions and the dimensions can be resorted as many as N! times to prevent the result of an identifiable subject in a dimension.

Referring back to step 206, if the aggregate reporting computing device 14 determines that a number of subjects associated with any of the dimensions is not below the threshold, then the “No” branch is taken to step 214. In step 214, the aggregate reporting computing device 14 generates an aggregate health report organized based at least in part on a plurality of report groups corresponding to one or more of the dimensions. The aggregate health report can include an indication of the report groups such as in the form of text, charts, and/or graphs, for example, although the report groups can be indicated in other ways.

The report groups can include subjects sharing a laboratory test result value, disease or condition risk level, abnormal values for an analyte or test panel, or high or low risk levels for an analyte or test panel, for example. Accordingly, the diagnostic test results obtained by the aggregate reporting computing device 14 in step 200 can be indicative, alone or in combination with a portion of the biometric and/or demographic information, of a risk level for one or more diseases or conditions of the subjects. Accordingly, the condition values each indicate a risk level associated with a respective one of the conditions for each of the subjects. In some examples, the condition values include a qualitative indication of a category of risk associated with the subject for one or more of the conditions, although numerical values on a relative scale can also be used for condition values in order to quantitatively define the risk level for the subjects.

In step 216, the aggregate reporting computing device 14 provides the aggregate report to the entity associated with the subjects for which the health data, demographic, and biometric information was obtained in step 200. The aggregate health report can be stored in the memory 22 and can be in the form of an electronic document, such as in a portable document format (PDF), and/or one or more web pages. The aggregate health report can be provided using the communication networks 16(1)-16(2) and 16(n) in response to a request from an entity representative user of one of the user electronic devices 12(1)-12(n), for example.

Accordingly, in this example, identifiable subjects are removed from the aggregate health report provided to the entity thereby maintaining anonymity of the subjects. In examples in which the entity is a corporation, the entity will therefore not be able to use the report as a basis for discriminating against employees based on health status. Optionally, steps 202-212 are not performed for entities such as health care providers for which anonymity may not be required.

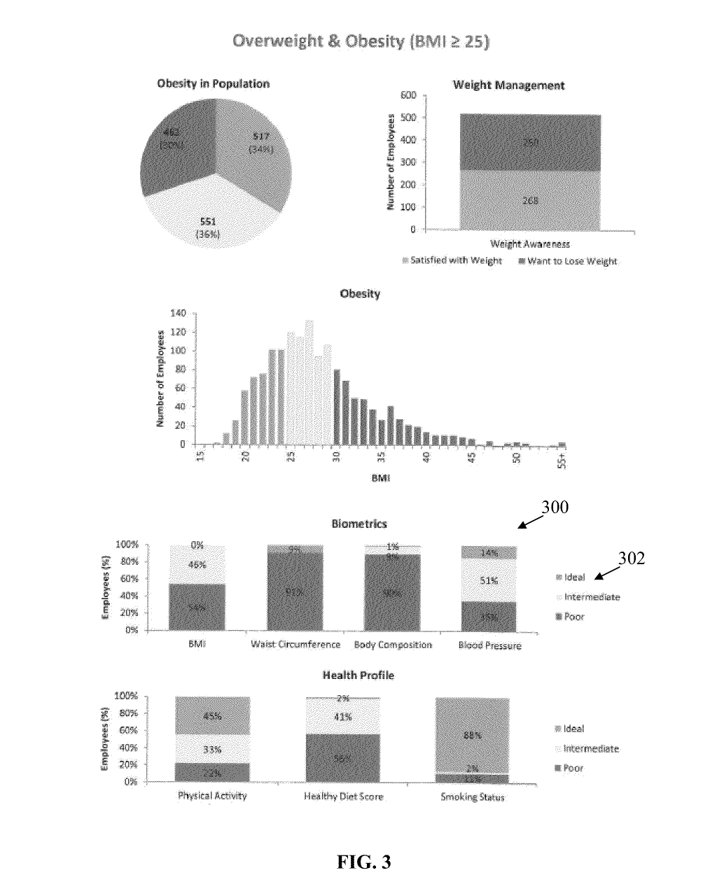

Referring to FIG. 3, a screen shot of biometric aggregate health data of an exemplary aggregate health report is illustrated. In this example, the aggregate health data is provided using various graph formats, although any method of presentation can be used. For example, aggregate BMI information is shown in a graph 300 as percentages of the population falling into one of ideal, intermediate, or poor categories 302. Aggregate health data corresponding to obesity, weight management, and a health profile are also illustrated in the aggregate health report 400, although any number and type of biometric aggregate health data and/or other aggregate health data can also be provided. Additionally, demographic aggregate health data can also be provided in the aggregate health report with categories and percentages reflecting the demographic characteristics of the population.

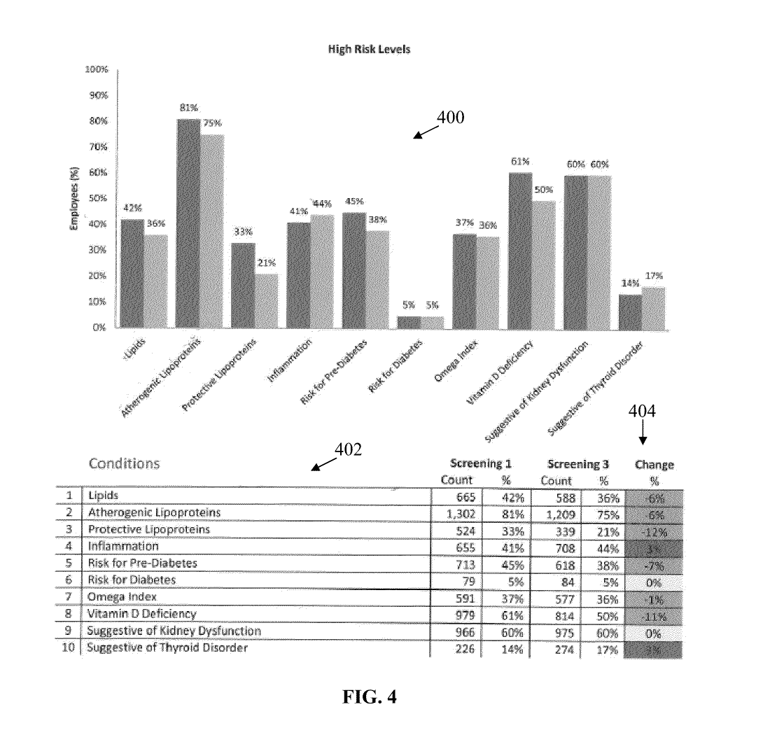

Referring to FIG. 4, a screen shot of aggregate condition values of an exemplary aggregate health report is illustrated. In this example, the aggregate condition values are provided using various graph and chart formats, although any method of presentation can be used. For example, chart 400 includes aggregate condition values corresponding to percentages of the population falling into a high risk category for each of the identified conditions.

In this example, aggregate condition values from two screenings are provided. Accordingly, in some examples, information from multiple screenings can be provided in step 210. By utilizing health data from multiple screenings, the aggregate health report can represent changes in the population occurring over time. In this example, the chart 302 includes the aggregate condition values presented in the graph 300 along with a column 304 indicating the percentage change over time.

With the aggregate health report provided in step 210, in one example, a corporate entity can gain insight as to how to direct a wellness program so as to provide the most likely benefit to the participating employees. In another example, a health care provider entity can identify how various treatments for one or more conditions have impacted the patient population over time. The aggregate health report can be used in other ways by these and other entity types.

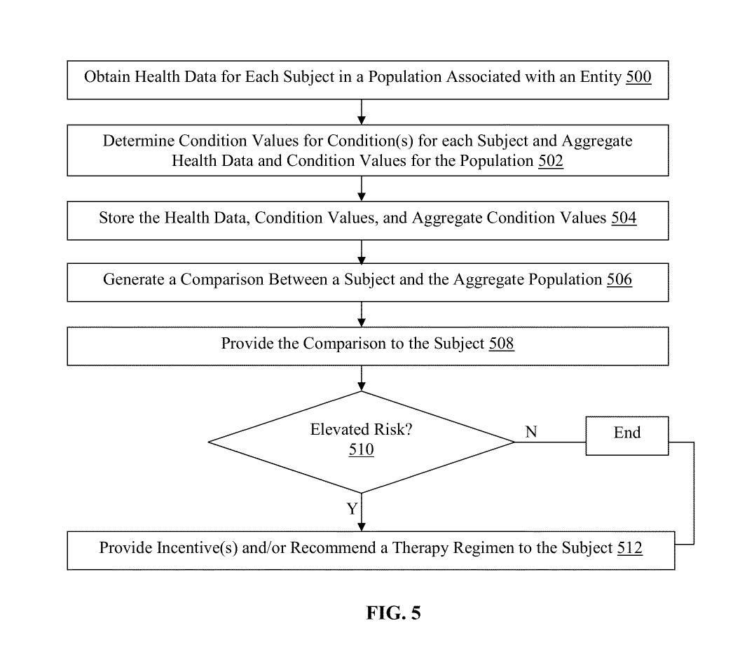

Referring more specifically to FIG. 5, an exemplary method for comparing health data for a subject to aggregate health data for an associated population is illustrated. In this example, in step 500, the aggregate reporting computing device 14 obtains health data for each subject in a population associated with an entity, as described and illustrated earlier with reference to step 200.

In step 502, the aggregate reporting computing device 14 determines condition values for condition(s) for each subject based on the health data and generates aggregate health data and aggregate conditions values for the population. In this example, the aggregate health data can be based on a percentage of the population having a test result and/or biometric and/or demographic value over or under an established value or in an established range, for example. In one example, the aggregate reporting computing device 14 calculates aggregate health data using BMI biometric health data and established BMI ranges for ideal, intermediate, and poor categories. Using the established ranges and obtained BMI biometric health data, the aggregate reporting computing device 14 calculates the aggregate health data as a percentage of subjects falling within the established ranges. In other examples, the aggregate health data includes an average value for one or more of the test results and/or biometric and/or demographic characteristics. Other methods of calculating aggregate health data and other types of aggregate health data can also be used.

In this example, in order to calculate the aggregate condition values, each of the subjects is assigned, based at least on the associated condition values, to one of a plurality of risk categories comprising a high risk category, an intermediate risk category, and a low risk category for developing one or more of the conditions. Based on the number of subjects assigned to each category for a particular condition as compared to the total number tested subjects, a percentage can be calculated by the aggregate reporting computing device 14. Accordingly, the aggregate condition values can indicate a percentage of the population affected by each of the conditions or in established risk categories for each of the conditions. Other methods of calculating aggregate condition values and other types of aggregate condition values can also be used.

In step 504, the aggregate reporting computing device 14 stores at least the health data, condition values, and aggregate conditions values in the memory 22, such as in the database 28. Optionally, the health data as well as the condition values are stored as associated with a unique identifier of a corresponding one of the subjects. Additionally, the aggregate reporting computing device 14 can store and aggregate condition values as well as the aggregate health data as associated with an indication of the population, and/or an indication of the entity associated with the population.

In step 506, the aggregate reporting computing device 14 generates a comparison between one of the subjects and the aggregate population. In order to generate the comparison, the aggregate reporting computing device 14 retrieves portions of the health data and/or condition values and aggregate health data and/or aggregate condition values stored in step 504 from the memory 22. Optionally, the comparison can be generated in response to a request from the subject or a representative of the entity, for example.

In step 508 in this example, the aggregate reporting computing device 14 provides the comparison generated in step 506 to the one of the user electronic devices 12(1)-12(n) associated with the subject. In one example, the comparison is provided in the form of one or more web pages including a comparison report sent to the one of the user electronic devices 12(1)-12(n) using the communication networks 16(1)-16(2) and 18, although other methods of communicating the generated comparison can also be used. The one or more web pages can include text, charts, and/or graphs or other indications of the generated comparison.

Optionally, in step 214, the aggregate reporting computing device 14 determines whether the subject has an elevated risk with respect to at least one of the conditions. In this example, the subject has an elevated risk for a condition when the condition value for the condition indicates a high risk, although other methods of identifying an elevated risk with respect to a condition can also be used.

If the aggregate reporting computing device 14 determines that the subject does not have an elevated risk with respect to at least one condition, then the “No” branch may be taken and the method ends. If the aggregate reporting computing device 14 determines that the subject does have an elevated risk with respect to at least one condition, then the “Yes” branch may be taken to step 216.

In step 216, the aggregate reporting computing device 14 optionally provides incentive(s) and/or recommends therapy regimen(s) to the subject. The therapy regimen can include drugs, supplements, and/or making and/or maintaining lifestyle choices such as changes in diet, changes in exercise, reducing or eliminating smoking, or a combination thereof, for example, although other therapy regimens can also be recommended. The incentive(s) and/or therapy regimen(s) can be previously established and stored in the database 28 of the memory 22.

Accordingly, the aggregate reporting computing device 14 can query the database 28 based on the conditions for which the subject has an elevated risk, as determined in step 214, and obtain corresponding and relatively generic incentive(s) and/or therapy regimen(s). In other examples, various other of the biometric and/or demographic health data associated with the subject can be used by the aggregate reporting computing device 14 to generate incentive(s) and/or therapy regimen(s) likely to be relatively specific to the subject.

With this technology, an aggregate health report can be generated and provided. The aggregate health report includes aggregate health data associated with diagnostic laboratory testing results for subjects in a population. The aggregate health report can be used by corporate entities in a corporate wellness program to encourage at-risk employees to share their results with, and seek treatment from, a health care provider. The aggregate health report can also be used by a health care provider to identify patients with relatively less improvement in health in response to a treatment and that may require targeted therapeutic intervention. Additionally, the aggregate health data can be used by subjects to compare individual results with corresponding aggregate results of an associated subset of the population as a motivational tool. This technology also advantageously prevents disambiguation of the identity of the subjects when the aggregate health report is provided to certain types of entities or a comparison of individual health data to aggregate health data is provided to one of the subjects in the population.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for aggregate reporting of health data, the method comprising:
obtaining, with an aggregate reporting computing device, health data for each of a plurality of subjects in a population associated with an entity, the health data comprising one or more of diagnostic laboratory testing results, biometric information, or demographic information;
allocating, with the aggregate reporting computing device, each of the subjects to one or more dimensions based on the obtained health data and one or more boundary conditions of each of the dimensions, the dimensions corresponding to biometric or demographic information of a specified type;
determining, with the aggregate reporting computing device, whether a number of subjects allocated to one of the dimensions is below a threshold; and
adjusting, with the aggregate reporting computing device, one or more of the boundary conditions for one or more of the dimensions when the number of subjects allocated to the one dimension is determined to be below the threshold.

2. The method of claim 1, further comprising generating and providing, with the aggregate reporting computing device, an aggregate health report organized based at least in part on a plurality of report groups, the report groups generated based at least in part on one or more of the dimensions.

3. The method of claim 1, wherein the one or more of the boundary conditions are modified such that disambiguation of any identifiable subjects is prevented.

4. The method of claim 1, further comprising:
determining, with the aggregate reporting computing device, whether no adjusting of the one or more boundary conditions for the one or more dimensions prevents disambiguation of the identifiable subjects; and
discarding, with the aggregate reporting computing device, at least the one dimension when it is determined that no adjusting of the one or more boundary conditions for the one or more dimensions prevents disambiguation of the identifiable subjects.

5. The method of claim 1, further comprising:
determining, with the aggregate reporting computing device, whether the adjusting resulted in a number of dimensions associated with a same type of biometric or demographic information falling below a threshold; and
discarding, with the aggregate reporting computing device, at least one or more of the dimensions associated with the same type of biometric or demographic information when it is determined that the adjusting resulted in a number of dimensions associated with the same type of biometric or demographic information falling below the threshold.

6. The method of claim 1, further comprising examining, with the aggregate reporting computing device, collective groups of the dimensions to prevent groups of dimensions from being used to disambiguate one another.

7. The method of claim 1, further comprising repeating, with the aggregate reporting computing device, the determining and the adjusting until a number of subjects allocated to each of the dimensions is determined not to be below the threshold.

8. A non-transitory computer readable medium having stored thereon instructions for aggregate reporting of health data comprising machine executable code which when executed by a processor, causes the processor to perform steps comprising:
obtaining health data for each of a plurality of subjects in a population associated with an entity, the health data comprising one or more of diagnostic laboratory testing results, biometric information, or demographic information;
allocating each of the subjects to one or more dimensions based on the obtained health data and one or more boundary conditions of each of the dimensions, the dimensions corresponding to biometric or demographic information of a specified type;
determining whether a number of subjects allocated to one of the dimensions is below a threshold; and
adjusting one or more of the boundary conditions for one or more of the dimensions when the number of subjects allocated to the one dimension is determined to be below the threshold.

9. The medium of claim 8 further comprising machine executable code which when executed by the processor, causes the processor to perform an additional step comprising generating and providing an aggregate health report organized based at least in part on a plurality of report groups, the report groups generated based at least in part on one or more of the dimensions.

10. The medium of claim 8, wherein the one or more of the boundary conditions are modified such that disambiguation of any identifiable subjects is prevented.

11. The medium of claim 8 further comprising machine executable code which when executed by the processor, causes the processor to perform additional steps comprising:
determining whether no adjusting of the one or more boundary conditions for the one or more dimensions prevents disambiguation of the identifiable subjects; and
discarding at least the one dimension when it is determined that no adjusting of the one or more boundary conditions for the one or more dimensions prevents disambiguation of the identifiable subjects.

12. The medium of claim 8 further comprising machine executable code which when executed by the processor, causes the processor to perform additional steps comprising:
determining whether the adjusting resulted in a number of dimensions associated with a same type of biometric or demographic information falling below a threshold; and
discarding at least one or more of the dimensions associated with the same type of biometric or demographic information when it is determined that the adjusting resulted in a number of dimensions associated with the same type of biometric or demographic information falling below the threshold.

13. The medium of claim 8 further comprising machine executable code which when executed by the processor, causes the processor to perform an additional step comprising examining collective groups of the dimensions to prevent groups of dimensions from being used to disambiguate one another.

14. The medium of claim 8 further comprising machine executable code which when executed by the processor, causes the processor to perform an additional step comprising repeating the determining and the adjusting until a number of subjects allocated to each of the dimensions is determined not to be below the threshold.

15. An aggregate reporting computing device comprising a processor and a memory coupled to the processor configured to be capable of executing programammed instructions comprising and stored in the memory to:
obtain health data for each of a plurality of subjects in a population associated with an entity, the health data comprising one or more of diagnostic laboratory testing results, biometric information, or demographic information;
allocate each of the subjects to one or more dimensions based on the obtained health data and one or more boundary conditions of each of the dimensions, the dimensions corresponding to biometric or demographic information of a specified type;
determine whether a number of subjects allocated to one of the dimensions is below a threshold; and
adjust one or more of the boundary conditions for one or more of the dimensions when the number of subjects allocated to the one dimension is determined to be below the threshold.

16. The device of claim 15, wherein the processor coupled to the memory is further configured to be capable of executing programmed instructions further comprising and stored in the memory to:
generate and provide an aggregate health report organized based at least in part on a plurality of report groups, the report groups generated based at least in part on one or more of the dimensions.

17. The device of claim 15, wherein the one or more of the boundary conditions are modified such that disambiguation of any identifiable subjects is prevented.

18. The device of claim 15, wherein the processor coupled to the memory is further configured to be capable of executing programmed instructions further comprising and stored in the memory to:
determine whether no adjusting of the one or more boundary conditions for the one or more dimensions prevents disambiguation of the identifiable subjects; and
discard at least the one dimension when it is determined that no adjusting of the one or more boundary conditions for the one or more dimensions prevents disambiguation of the identifiable subjects.

19. The device of claim 15, wherein the processor coupled to the memory is further configured to be capable of executing programmed instructions further comprising and stored in the memory to:
determine whether the adjusting resulted in a number of dimensions associated with a same type of biometric or demographic information falling below a threshold; and
discard at least one or more of the dimensions associated with the same type of biometric or demographic information when it is determined that the adjusting resulted in a number of dimensions associated with the same type of biometric or demographic information falling below the threshold.

20. The device of claim 15, wherein the processor coupled to the memory is further configured to be capable of executing programmed instructions further comprising and stored in the memory to:
examine collective groups of the dimensions to prevent groups of dimensions from being used to disambiguate one another.

21. The device of claim 15, wherein the processor coupled to the memory is further configured to be capable of executing programmed instructions further comprising and stored in the memory to:
repeat the determining and the adjusting until a number of subjects allocated to each of the dimensions is determined not to be below the threshold.
